(19) United States
(12) Patent Application Publication
(10) Pub. No.: US 2026/0366595 A1
(43) Pub. Date: Nov. 19, 2026

(54) POWER TRANSMISSION BELT AND CORRESPONDING TRANSMISSION SYSTEM

(71) Applicant: DAYCO EUROPE S.R.L., Chieti (IT)

(72) Inventors: Marco DI MECO, Chieti (IT); Fabio NARDONE, Chieti (IT); Massimiliano DELLI ROCIOLI, Chieti (IT)

(73) Assignee: DAYCO EUROPE S.R.L., Chieti (IT)

(21) Appl. No.: 19/154,082

(22) PCT Filed: Feb. 6, 2024
(86) PCT No.: PCT/IB2024/051073

§ 371 Date: Aug. 6, 2025

(30) Foreign Application Priority Data
Feb. 7, 2023 (IT) 102023000002019

(51) Int. Cl. F16G 1/10; F16G 1/28

(52) U.S. Cl. CPC F16G 1/10; F16G 1/28

(57) ABSTRACT

Power transmission belts have a belt body that includes a first elastomeric material, a plurality of non-metallic cords embedded in the belt body, a back, and a toothing. The toothing is covered by a first cover material not made of metallic material. The power transmission belts have a Q value that is greater than 1.45. Q is calculated be the following equation:

Q=Wg/((E*H−(H)*H*Tan(theta))*Wi*N+N*P*Wi*T)).

### CROSS-REFERENCE TO RELATED APPLICATIONS

This patent application claims priority from Italian Patent Application No. 102023000002019 filed on Feb. 7, 2023, the entire disclosure of which is incorporated herein by reference.

### TECHNICAL SECTOR

The present invention relates to a power transmission belt and, in particular, to a toothed belt and the relative transmission system.

### STATE OF THE PRIOR ART

The present invention is preferably used for the transmission of motion in a transmission assembly comprising a motor.

The transmission of motion preferably occurs using synchronous power transmission belts, also referred to as toothed belts.

The belt can be used both for motion transmission in motor vehicles and for industrial applications.

Transmission belts generally comprise a body made of elastomeric material, preferably HNBR for toothed belts, a plurality of resistant thread-like inserts embedded longitudinally in the body, and a coupling portion integrally connected to the body and comprising a plurality of teeth transverse to the sliding direction of the belt in use in the case of toothed belts.

A typical problem with toothed belts is that they are very noisy, particularly at low motor speeds, making the belt “audible” while driving.

Numerous studies have been carried out to solve this problem, and numerous solutions have been proposed, such as covering the working surface with fabrics or materials which allow dampening the noise generated, for example, from the meshing of the belt on the pulley.

However, the belts currently used do not allow completely solving the aforementioned problem.

Therefore, there is a constant search for less noisy transmission belts which allow meeting the increasingly stringent specifications imposed by car manufacturers and which, in particular, still allow having a high durability.

### SUMMARY OF THE INVENTION

The object of the present invention is to make a transmission belt which solves the above-mentioned problems and is achieved by a belt according to claim 1.

### BRIEF DESCRIPTION OF THE DRAWINGS

FIG. 1 is a schematic and partial view of a portion of a toothed belt

FIG. 2 is a diagram of a longitudinal section of a toothed belt which allows to represent the values used in the definitions of the present invention;

FIG. 3 is a table showing a series of examples of the belt according to the invention and comparisons

FIG. 4 is a graph schematically depicting a noise test;

FIG. 5 is a transmission system used for the noise test of FIG. 4;

FIG. 6 is a graph depicting the comparative results of a noise test on a known belt and a belt according to the present invention.

### DESCRIPTION OF THE INVENTION

“Main elastomer” means that it is present in the mixture constituting the belt body for at least more than 60% by weight calculated on the total weight of all the components in the mixture, thus including any type of additive or fillers or elastomers.

“First elastomeric material is essentially constituted” means that, in addition to additives, small percentages of other polymers or copolymers can be added to the compound without adversely affecting the functionality and chemical compatibility between the body mixture and the other constituent elements of the toothed belt, and thus without departing from the scope of the present invention.

In the following, although they are widely known to the person skilled in the art, for the various definitions of the belt values, reference has generally been made to ISO9010:1997 and more specifically to the values as illustrated in FIG. 2.

More specifically, fitting radius (R) means the radius of the circle joining the land area with the toothed side, as illustrated in FIG. 2.

Tooth root means the section generated by the intersection of the two tangent lines which are symmetrical with respect to the tooth axis with the land area line.

In the context of the present invention, pressure angle (teta) means the angle which forms between the centreline of the tooth perpendicular to the land area and the tangent at the meeting point between the land area radius and the tooth side.

“Not made of metallic material” means that the component of the belt does not comprise metallic material or comprises metallic material in an amount by weight less than 50% with respect to the weight thereof.

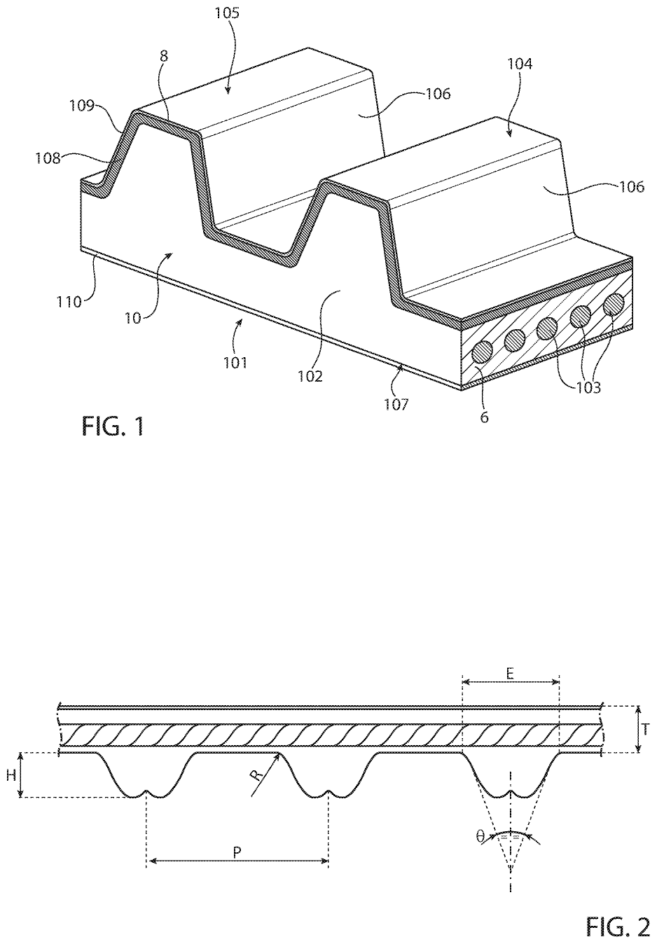

In an embodiment of the invention in FIG. 1, a toothed belt is indicated overall with 101.

The toothing can be helical, preferably with a helix angle comprised between 1° and 15°.

The belt 101 comprises a body 102 comprising a first main elastomeric material. A plurality of resistant longitudinal thread-like inserts 103 also alternatively referred to as “cords” not made of metallic material is embedded in the body 102.

Cords not made of metallic material are defined as cords which either contain no metallic material or the metallic material represents less than 50% by weight of the cord itself, preferably less than 30% by weight, even more preferably less than 10% by weight, and thus have minimal influence on the Q factor.

In other words, as is well known, it is in fact possible to make hybrid cords from two or more materials. In the case of the use of such cords in belts according to the present invention, the wires in metallic material forming part of the hybrid cord must weigh less than 50% by weight, preferably less than 30% by weight, even more preferably less than 10% by weight.

The belt further comprises a toothing 104 formed by a plurality of teeth 106 which in use constitute the working surface 105, i.e., the surface which meshes on a corresponding pulley of the transmission system.

The toothed belt further comprises a back 107 opposite the working surface 105.

Both the toothing 104 and the back 107 can be covered with a cover material which is generally used to modify the mechanical properties of the surface. The cover material can for example be a fabric, a polymer film, a treatment, an anti-friction coating, etc.

Alternatively, it is also possible to use several cover materials such as, for example, a fabric onto which a layer of a mixture of elastomeric material and PTFE is calendared.

According to a preferred form of the present invention, the cover material preferably contains less than 50% by weight of metals, more preferably less than 30% by weight, even more preferably less than 10% by weight and even more preferably does not contain metals.

Within the scope of the present invention, with reference to the power transmission belt, the following is defined:
Wg=Weight (gr)
P=Pitch (cm)
N=Number of teeth
Wi=Width (cm)
T=Land area (cm)
H=Tooth height (cm)
E=Tooth root (cm)
Teta=angle Θ (rad)
A=tooth area=E*H−Ae (cm2)

Q=Wg/((E*H−(H)*H*Tan(theta))*Wi*N+N*P*Wi*T))

According to a preferred form of the present invention, it has been verified that the belt has less noise when Q is greater than 1.45. Preferably Q is comprised between 1.45 and 2. Alternatively Q is greater than 1.50.

It has been verified that when the Q parameter takes on a value greater than 1.45, the belt noise decreases, in particular in combination with a motor speed and torque when the belt noise is particularly heard by the user.

In a preferred embodiment, the pitch P of the belt is comprised between 0.1 and 2 cm, more preferably the pitch P is comprised between 0.15 and 1.6 cm.

Preferably to obtain the Q parameter with a value greater than 1.45, the belt body is made of a mixture comprising a material with a density greater than 1.3 g/cm³. More preferably, the material with a density greater than 1.3 g/cm³ is added to the mixture in the form of first fibers or powders or liquids. Even more preferably, the material with a density greater than 1.3 g/cm³ constitutes more than 35% by weight with respect to the total weight of the belt body, more preferably more than 40% by weight, even more preferably more than 50% by weight.

The upper limit is given by the continued performance of the elastomeric material to hold the remaining belt components together.

Even more preferably, the material with a density greater than 1.3 g/cm³ constitutes 50 to 60% by weight of the body.

Preferably the material with a density greater than 1.3 g/cm³ is chosen from the group consisting of metals and minerals or mixtures thereof.

More preferably if metal is the material with a density greater than 1.3 g/cm³, it is added in an amount greater than 35% by weight.

More preferably if the material with a density greater than 1.3 g/cm³ is mineral, it is added in an amount greater than 45% by weight.

Preferably the material with a density greater than 1.3 g/cm³ is steel or barite.

Preferably the material with a density greater than 1.3 g/cm³ is in powder form, but it can also be added in liquid or fiber form or in any other form which allows compatibility with the mixture constituting the body.

More preferably, if it is steel or barite, it is added in powder form.

Alternatively, it is possible to vary the Q parameter by acting on other belt elements so as to obtain a lower noise level regardless.

Preferably, the elastomeric material forming the belt body 101 is selected from the group consisting of natural rubber (NR), polychloroprene (CR), acrylonitrilebutadiene (NBR) and related hydrogenated elastomers known as hydrogenated acrylonitrilebutadiene (HNBR) or zinc salts of hydrogenated acrylonitrilebutadiene graphed with unsaturated carboxylic acid esters, polyisoprene, styrene-butadiene rubbers, ethylene-alpha-olefin elastomers, EPM, EPDM, polyurethane, fluoro elastomers, ethylene-acrylic elastomers (AEM), brominated butyl, chlorosulfonated polythene (CSM) or alkyl chlorosulfonate, chlorinated polythene, epoxidized natural rubber, SBR, carboxylated NBR, carboxylated HNBR, ACM and mixtures of these compounds it is a mixture of one or more Most preferably, copolymers, obtained from a diene monomer and a monomer containing nitrile groups, optionally at least partly modified with a salt of an unsaturated carboxylic acid.

Although the embodiment in which the body mixture comprises only one elastomer is preferable, it is also possible to add further elastomers such as nitrile rubbers, advantageously acrylonitrile butadiene rubbers, known by the acronym NBR. Alternatively, hydrogenated acrylonitrile butadiene or HNBR or even XHNBR, viz. hydrogenated and carboxylated acrylonitrile butadiene.

Alternatively, the elastomeric material of the body 102 comprises as a further elastomeric material at least one polyolefin copolymer or a rubber containing acrylonitrile units modified with a salt of an unsaturated carboxylic acid.

More advantageously, the unsaturated carboxylic acid is methacrylic or acrylic acid and said salt is a zinc salt of methacrylic or acrylic acid. Even more advantageously, a zinc salt of methacrylic acid is used.

For example, advantageously the elastomers are used sold by Zeon under the names: ZSC 1295, ZSC 2095, ZSC 2195, ZSC 2295, ZSC 2295L, ZSC 2295R and ZSC 2395, ZSC2195CX.

In addition to elastomeric materials, the body mixture can comprise conventional additives such as, for example, reinforcing agents, fillers, pigments, stearic acid, accelerators, curing agents, antioxidants, activators, initiators, plasticisers, waxes, pre-curing inhibitors, antidegradants, process oils and the like.

Advantageously, the body mixture further comprises reinforcing fibers, more advantageously the mixture comprises between 1 and 20% by weight of fibers, even more preferably between 5 and 15% by weight.

The reinforcement fibers have a length comprised between 0.1 and 10 mm, preferably between 1 and 6 mm, even more preferably between 1 and 3 mm.

The use of fibers makes it possible to further increase the mechanical characteristics of the mixture constituting the body.

The fibers are therefore present throughout the body, including the region surrounding the cords, which allows ensuring a greater rigidity.

Preferably, the fibers are cut fibers.

The reinforcement fibers preferably comprise at least one substance selected from the group consisting of polyamide, aromatic polyamide, polyester, glass, PBO carbon fibers, more advantageously they are aromatic polyamides or aramids, e.g., Technora® fibers, which can be made to adhere to the mixture by means of a treatment, preferably RFL-based.

The treatment used can also have a base of VP-SBR, viz. a copolymer of vinylpyridine and styrenebutadiene.

Aramid fibers, such as Teijn's Technora® fibers with a length of 3 mm, proved particularly effective.

The cords 103 are formed by a plurality of threads or strands or filaments and each thread is formed by a plurality of filaments.

The cords preferably comprise high-modulus fibers, more preferably at least one material selected from the group consisting of carbon, PBO, aramid, polyamide, glass or polyester fibers.

The cords can advantageously be of the “hybrid” type, viz. composed of at least a first fibrous material and a second fibrous material.

The use of cords 103 consisting of two materials in the form of different fibers or filaments allows a better adhesion of the cord 3 to the mixture constituting the belt body.

The cords 103 are preferably treated with an aqueous-based treatment known as reactive impregnation, but can also be treated in a similar manner or with RFL, viz. a composition based on latex, resorcinol and formaldehyde.

If the cords 103 comprise two fibrous materials, both the first and the second material are preferably selected from the group consisting of glass fibers, aramid fibers, polyester fibers, carbon fibers, PBO fibers, polyamide fibers, polyketone (POK) fibers, PEEK fibers, polyvinyl acetate (PVA) fibers, liquid crystal fibers (LPC) and PEN fibers.

The first material preferably has a lower modulus than the second material and is preferably wrapped around the second material.

Preferably, in the cross-section the second material occupies a surface comprised between 15 and 75% with respect to the overall surface of the section itself. Even more preferably, the second material occupies a surface comprised between 45 and 55% with respect to the total surface area.

Even more advantageously, in cross-section the fibers of the two materials occupy similar surfaces, so that the positive characteristics of both are balanced as much as possible to obtain the best performance on the belt.

The first material is preferably glass fiber and the second material is preferably carbon fiber.

Preferably, the fibers of the first material are wrapped around the fibers of the second material so as to externally cover the fibers of the first material at least in part, and even more preferably so as to entirely cover the fibers of the second material.

Preferably, the cords 103 have a Lang's Twist type twist, viz. two twists in the same direction.

The number of filaments forming the cord, as well as the number of base filaments or the titer or the entire creation of the insert, can be varied.

In order to achieve the best performance, the number of strands formed from the fibers of the first material is preferably comprised between 3 and 18, preferably between 8 and 15.

Advantageously, the working surface of the transmission belt 101 is covered with a cover material 108. The cover material 108 is most advantageously selected from the group consisting of woven fabric, knitted fabric or non-woven fabric.

The cover material 108 for covering the toothing 105 or the optional cover material of the back 110 are preferably constituted by a fabric formed by one or more layers and can be obtained by means of various weaving techniques, for example, by means of the weaving technique known as 2x2 twill.

The cover fabrics preferably have a structure constituted by a warp and by a weft.

More advantageously if a woven fabric is used, the cover material 108, 110 comprises threads extending substantially in the longitudinal direction of the toothed belt. Generally, such longitudinal threads are the weft threads.

Advantageously, the weft threads comprise at least one elastic thread and at least one thread with high thermal and mechanical resistance, such as for example aliphatic polyamide, aromatic polyamide or aramid, PET, polyesters, but also natural-based fabrics such as cotton, possibly also in complex or blended structures with several threads of a chemical nature wrapped on top of each other.

Even more advantageously, the weft threads comprise an elastic thread and at least a first and a second thread, more preferably the first and the second thread are polyamides, even more preferably they are of an aliphatic polyamide such as polyamide 6, 6 and an aromatic polyamide, such as for example a poly-para-aramide, as for example illustrated in patent EP0965271.

In a preferred embodiment both threads wrapping the elastic thread or threads are made of polyaramide.

In a particularly preferred embodiment of the invention, the working surface is covered by a fabric in which a first thread of polyaramide fibers is wrapped around an elastic thread in a first direction S and a second thread of polyaramide fibers is wrapped in the opposite direction Z around the first thread.

Advantageously, the weft threads comprise para-polyaramide fibers.

For example, the weft threads can be formed by wrapping a pair of para-polyamide threads, for example Technora threads, around a polyurethane thread.

Advantageously, the warp threads comprise meta-polyaramide fibers.

Advantageously, the fabric does not comprise metallic threads. Alternatively, the metallic threads are in a smaller amount by weight with respect to the non-metallic threads, more advantageously they are less than 30% by weight, even more advantageously they are less than 10& by weight.

The fabric 108, 110 is generally subjected to a plurality of treatments.

Such treatments have proven to be very advantageous so that the belt is capable of having a long life in continuous contact with high-temperature oil.

Advantageously, a first treatment can be based on poly-isocyanates useful for adhering the polyaramide fibers and thus the entire fabric to the body elastomers.

Advantageously, the fabric 108, 110 is subsequently subjected to a second treatment with RFL.

Also in this case, preferably the latex is an elastomeric material formed by a mixture of one or more copolymers, obtained from a diene monomer and a monomer containing nitrile groups, modified with a salt of an unsaturated carboxylic acid.

Advantageously, the fabric 108, 110 is further subjected to a third treatment based on a rubber, also known as cement, preferably comprising an elastomeric material, more preferably a hydrogenated nitrile rubber, even more preferably an elastomeric material formed from a mixture of one or more copolymers, obtained from a diene monomer and a monomer containing nitrile groups, modified with a salt of an unsaturated carboxylic acid, and even more preferably the same elastomeric material constituting the body.

Furthermore, preferably the fabric of the working surface 105 of the toothed belts 101 of the present invention is covered with a fourth treatment, even more preferably such a treatment forms a layer 109 which is, for example, calendered on top of the fabric to form a separate layer.

Such a layer 109 preferably comprises a fluorinated polymer, for example PTFE, and a treatment elastomer, for example a material similar to that used for the body mixture or a fluoroelastomer.

Advantageously, one or more copolymers formed from a monomer containing nitrile groups and a diene, and more preferably an elastomeric material formed from a mixture of one or more copolymers, obtained from a diene monomer and a monomer containing nitrile groups, modified with a salt of an unsaturated carboxylic acid, and even more preferably the same elastomeric material used as the main elastomer in the body compound, can therefore be used as elastomers for the fourth treatment.

By appropriately choosing the quantities of the materials of which the fourth treatment is composed, a covering layer is conveniently formed which is distinct and separate from the fabric itself, also referred to hereinafter as the resistant layer 109.

Advantageously, the elastomeric material is present in the resistant layer 109 in a greater quantity in phr than the sum of the fluorinated elastomer and the second elastomeric material.

The thickness of the resistant layer 109 is advantageously comprised between 0.03 mm and 0.3 mm.

The resistant layer 109 can be arranged above the fabric 108 in different manners. It is preferably arranged by means of a calendering step.

An adhesive material can be arranged between the fabric 109 and the resistant layer 108 to improve the adhesion of the resistant layer 109 on the fabric 108.

Preferably the resistant layer 108 has a weight comprised between 200 and 400 g/m² to ensure the necessary resistance.

Preferably, the back 107 of the belt is also covered with a fabric, even more preferably the fabric on the working surface 105 and on the back 107 are the same and are treated with the same treatments and with the same materials.

Preferably, the fabric covering the back 107 is also treated with different treatments. It has proven particularly advantageous to treat the back 107 with a treatment similar to the fourth treatment of the fabric 108 covering the working surface 105 described above. More advantageously, such a fourth treatment forms a resistant layer on top of the Even more preferably, the resistant layer covering the fabric 110 covering the back 107 is the same as that covering the fabric 108 covering the teeth.

From an examination of the characteristics of the belt made according to the present invention, the advantages that it allows obtaining are evident.

By using a toothed transmission belt, considerable improvements were achieved according to the present invention and, in particular, the above-mentioned problems could be overcome. In particular, it is possible to achieve lower noise and have a comparable belt life.

The invention will be described below by means of examples, but is not intended to be limited thereto.

Examples according to the invention and comparisons 1-13

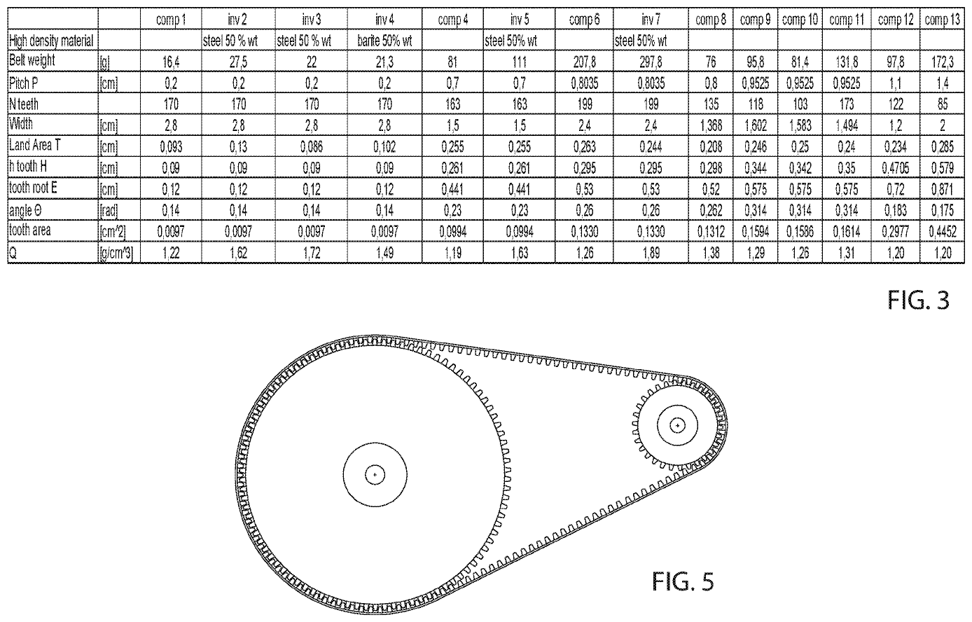

The table of FIG. 3 shows a series of belts according to the invention (designated with Inv) and comparative (designated comp) for which the different values leading to the calculation of the Q parameter were calculated.

The belts according to the invention are identical in composition and shape to some comparative belts except for the addition of a high-density material.

The high-density material added to the belts according to the invention is steel powder and is added in an amount of 50% by weight.

The comparative belt of example 1 comprises a body made with the mixture of table 1.

TABLE 1

| | phr | % |
|---|---|---|
| Carbon black N375 | 40 | 17 |
| Peroxide 14-40 B-g | 7 | 3 |
| Glicoester plasticizer | 15 | 6 |
| Magnesium oxide | 2 | 1 |
| Silica | 62 | 26 |
| Antioxidant 445 | 2 | 1 |
| Zinc oxides | 3 | 1 |
| HNBR | 100 | 42 |
| Other additives | 9 | 4 |

In the belt of the invention of example 2, 50% by weight of steel powder is added to the composition of Table 1.

The cover fabric of the belt is made of polyamide 66 with a raw weight of 275 g/m² and is treated with an HNBR mixture.

The toothing is helical. The cord is type E glass with a water-based treatment known as reactive impregnation.

The belt further comprises a nylon polyamide 66 back fabric with a raw weight of 200 g/m².

Such a belt is marketed by Dayco under the number 998009.

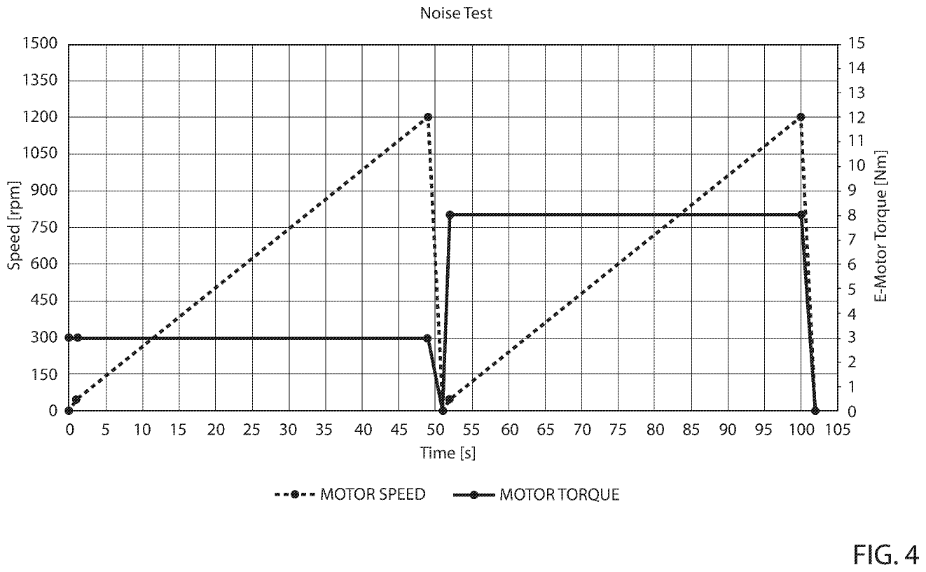

The belts are subjected to a noise test depicted in FIG. 4.

The test to which the three belts are subjected is a constant torque test, which occurs by mounting the belts in the transmission system illustrated in FIG. 4.

The driving pulley rotates with a speed ramp from 0 to 1200 revolutions per minute (RPM). The driven pulley applies a constant resistant torque in a first speed ramp of 3 Nm and in a second speed ramp of 8 Nm.

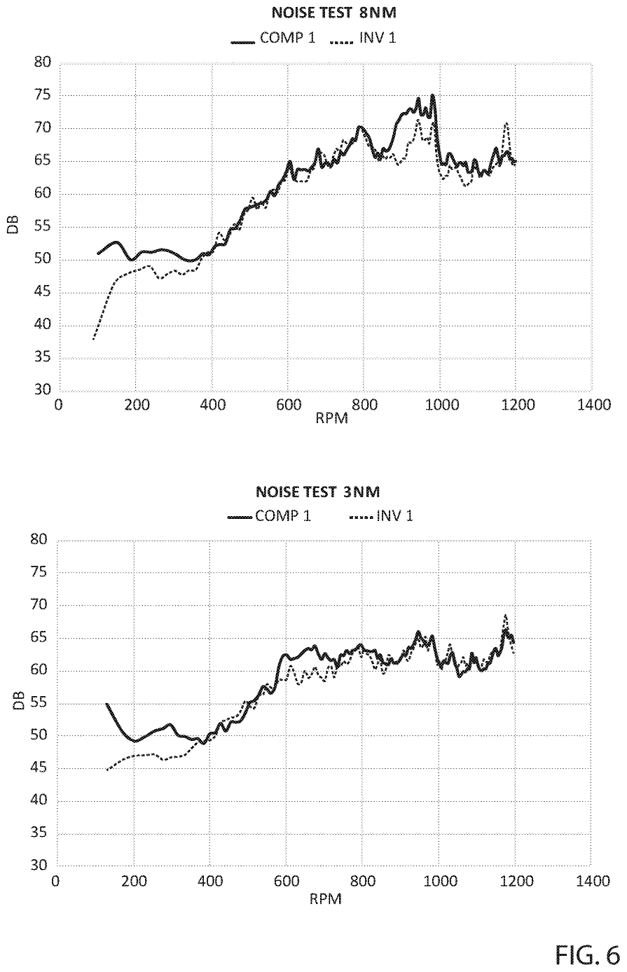

The graph in FIG. 6 is obtained, showing the noise as the motor speed increases with a torque of 3 and 8 Nm.

It is evident that the line of the belt of the invention has a lower noise progression, in particular at low and medium regime and therefore has a lower noise level precisely at the motor speed in the area where it is most noticeable to the user.

1. A power transmission belt comprising:
a belt body comprising:
a first elastomeric material,
a plurality of cords not made of metallic material embedded in the belt body,
a back, and
a toothing covered with at least one first cover material not made of metallic material, wherein:
Wg=Weight (gr)
P=Pitch (cm)
N=Number of teeth
Wi=Width (cm)
T=Land area (cm)
H=Tooth height (cm)
E=Tooth root (cm)
Theta=angle Θ (rad)
A=tooth area=E*H−Ae (cm2)
Q=Wg/((E*H*H*Tan)*Wi*N+N*P*Wi*T))
characterised in that: Q>1.45.

2. The power transmission belt according to claim 1, wherein Q is between 1.45 and 2.

3. The power transmission belt according to claim 1, wherein Q>1.50.

4. The power transmission belt according to claim 1, wherein P is between 0.1 and 2 cm.

5. The power transmission belt according to claim 1, wherein P is between 0.15 and 1.6 cm.

6. The power transmission belt according to claim 1, wherein the belt body comprises a material having a density greater than 1.3 g/cm³.

7. The power transmission belt according to claim 6, wherein said material having a density greater than 1.3 g/cm³ is added to the compound in the form of first fibers or powders or liquids.

8. The power transmission belt according to claim 6, wherein said material with density greater than 1.3 g/cm³ constitutes more than 35 percent by weight of the total weight of the belt body.

9. The power transmission belt according to claim 6, wherein said material with density greater than 1.3 g/cm³ constitutes 40 to 60 wt % of said belt body.

10. The power transmission belt according to claim 6, wherein said material with density greater than 1.3 g/cm³ is selected from the group consisting of metals or minerals.

11. Power transmission belt according to claim 6, wherein said material with density greater than 1.3 g/cm³ is steel or barite.

12. The power transmission belt according to claim 1, wherein the belt body comprises second fibers made of a material selected from the group consisting of glass, aramid, polyester, carbon, poly(p-phenylene-2,6-benzobisoxazole) PBO, polyamide, polyketone, polyether ether ketone, polyvinyl acetate, liquid crystal, polyethylene naphthalate.

13. The power transmission belt according to claim 1, wherein the elastomeric material is selected from the group consisting of natural rubber (NR), polychloroprene (CR), acrylonitrilebutadiene (NBR) and related hydrogenated elastomers known as hydrogenated acrylonitrilebutadiene (HNBR) or zinc salts of hydrogenated acrylonitrilebutadiene graphed with unsaturated carboxylic acid esters, polyisoprene, styrene-butadiene rubbers, ethylene-alpha-olefin elastomers, EPM (ethylene propylene monomer), EPDM (ethylene propylene diene monomer), polyurethane, fluoro elastomers, ethylene-acrylic elastomers (AEM), brominated butyl, chlorosulfonated polythene (CSM) or alkyl chlorosulfonate, chlorinated polythene, epoxidized natural rubber, SBR, carboxylated NBR, carboxylated HNBR, ACM and mixtures of these compounds.

14. The power transmission belt according to claim 1, wherein the teeth are helical with a helix angle between 1° and 15°.

15. A power transmission system comprising a belt according to claim 1.
